(19) United States
(12) Patent Application Publication
(10) Pub. No.: US 2004/0161489 A1
(43) Pub. Date: Aug. 19, 2004

(54) Injection molding of thermoplastic parts

(76) Inventors: C. Robin Hwang, Cary, NC (US); Frank E. Martin, Durham, NC (US); John D. Walker, Fairfax, VA (US)

Correspondence Address: DAVID W. HIGHET, VP AND CHIEF IP COUNSEL, BECTON, DICKINSON AND COMPANY, 1 BECTON DRIVE, MC 110, FRANKLIN LAKES, NJ, 07417-1880, US

(21) Appl. No.: 10/779,165

(22) Filed: Feb. 13, 2004

Related U.S. Application Data
(63) Continuation of application No. 10/273,796, filed on Oct. 18, 2002.
Application No. 10/273,796 is a continuation of application No. 09/562,875, filed on May 1, 2000, now abandoned.

(51) Int. Cl. B29C 45/02

(52) U.S. Cl. 425/556; 425/552; 425/577; 425/572

(57) ABSTRACT

A molding apparatus and molding method are provided for molding of small objects from a thermoplastic elastomer. The apparatus includes a heated transfer plate assembly, an insulation plate assembly adjacent the transfer plate assembly and a cooled cavity plate assembly. The transfer plate assembly is heated sufficiently to maintain a thermoplastic elastomer in a molten state. The cavity plate assembly is cooled sufficiently to solidify a thermoplastic elastomer injected into cavities of the cavity plate assembly.

### CROSS-REFERENCE TO RELATED APPLICATIONS

This application is a continuation of U.S. application Ser. No. 10/273,796 filed Oct. 18, 2002 which is a continuation of U.S. application Ser. No. 09/562,875 filed May 1, 2000.

### BACKGROUND OF THE INVENTION

This invention relates to a method and apparatus for molding thermoplastic elastomers.

A medical syringe includes a generally cylindrical barrel with a widely opened proximal end, a narrowly opened distal end and a fluid receiving chamber therebetween. An elastomeric stopper is mounted in the open proximal end of the syringe barrel. The prior art stopper typically is generally cylindrical and typically has at least one annular bead extending thereabout. The outer diameter of the bead exceeds the inside diameter of the fluid receiving chamber by a sufficient amount to ensure a fluid-tight seal. The proximal end of the prior art syringe stopper typically includes a central recess with a small diameter entry. The recess is dimensioned and configured to enable the stopper to be mounted over the distal end of a prior art piston. Distal movement of the stopper and piston in the syringe barrel urges fluid from the chamber and through the narrow opening at the distal end of the syringe barrel. Conversely, proximal movement of the stopper and piston draws fluid through the narrowly opened distal end of the syringe barrel and into the chamber.

Prior art syringe barrels vary considerably in size. For example, the volumes of the fluid receiving chambers of prior art syringe barrels may vary from 0.3 cc to 60 cc. Thus, stoppers for these prior art syringe barrels vary in diameter from a few millimeters to a few centimeters.

Elastomeric stoppers also are used to seal the open ends of tubes. For example, prior art blood collection systems often include evacuated tubes that are sealed with an elastomeric stopper. The prior art blood collection system includes a needle holder. A needle cannula is mounted to the holder and has pointed proximal and distal ends. The pointed proximal end of the needle cannula extends into the needle holder, and pierces the elastomeric stopper of the evacuated blood collection tube that is inserted into the needle holder. Elastomeric stoppers for evacuated blood collection tubes must meet gas diffusion specifications as well as fluid-tight sealing specifications that are similar to the specifications of the stoppers used with a syringe.

Similarly, the electrical and automotive industries employ small thermoset rubber parts in many applications. O-rings, wiring harness connectors, and grommets are examples these types of parts formed from thermoset rubbers. Often, the thermoset rubber selected for these applications is silicone based. There are many other applications of resilient thermoset rubber gaskets in packaging, printing equipment and electronic equipment.

Prior art resilient parts typically have been formed from an elastomeric thermoset rubber. Stoppers employed with syringes can be made from either a natural rubber or a synthetic rubber. Many stoppers used for blood collection tubes are made of a halobutyl rubber. A thermoset rubber undergoes a chemical reaction process called cross-linking or vulcanization as energy is applied during molding. The thermoset materials generally include reactive compounds called initiators that may leave undesirable extractable residues if incompletely reacted. In contrast, a thermoplastic elastomer softens when sufficiently heated becomes molten and flows as a liquid in the molding apparatus. When the thermoplastic material is allowed to cool, it again becomes resilient and shape retaining. Thermoplastic materials do not require initiators and generally do not have extractable residues.

Thermoset rubber parts traditionally are manufactured by compression molding. The prior art compression molding process requires “green” or uncured rubber pellets or sheets to be placed inside a mold. A direct pressure and sufficient elevated temperature is then applied to the rubber in the mold cavity, forming the rubber material into the shape of the mold cavity and curing (crosslinking) the rubber. Excess rubber is allowed to escape from the cavity under the controlled molding conditions. Compression molding generally produces rubber parts that require substantial secondary trimming operations to separate the finished parts from the trim. The trimming operation generates waste, may cause quality control issues and generally increases the production cost.

The prior art also includes a hybrid of injection and compression molding in which a metered shot of an elastomeric thermoset rubber melt is injected into a slightly open mold. The mold is then closed for forming the melt to the shape of the mold cavity and curing the rubber. Injection compression molding enables lower clamp pressure than conventional compression molding. However, injection compression molding still generally requires substantial trimming of the molded elastomeric parts with the same problems described above.

Transfer molding is a refinement of compression molding and has been used for high cavitation, small rubber components, such as automotive bushings and grommets. The prior art transfer molding process uses a molding apparatus having three components, namely, upper and lower parts which are attached to the platens of a hydraulic press, and a middle part that can be moved transverse to the direction of movement of the press. An elastomeric thermoset rubber compound is forced from an open transfer pot in the upper part, through individual channels or runners in the middle part and into heated mold cavities formed in the lower part. At the end of the molding cycle, the rubber compound in all three components of the mold is cured and the molded parts are removed as finished products. Parts formed by the transfer molding process generally have less flash and thus generally require less secondary trimming than parts formed by compression molding. However a large cured pad with runners remains in the transfer pot, and must be disposed of as scrap. The reduction of the secondary trimming operation generally improves quality control. However, the handling and disposal of any scrap such as the cured pad can be costly.

It is apparent that eliminating the cured transfer pad could reduce the volume of scrap. The elimination of the transfer pad may be accomplished by positioning a temperature controlled insulating layer with individual runners or sprues to connect the transfer pot and mold cavities, as disclosed in U.S. Pat. No. 3,876,356. The thermal separation of the transfer pot from the heated mold cavities serves to keep the transfer pot temperature below the curing temperature and thus prevent the vulcanization of rubber in the pot. According to the disclosure of this patent, at the end of the molding cycle, only the finished products and a portion of the rubber in the runners are cured. Since the rubber in the transfer pot and in the portions of runners adjacent to the pot are maintained below the curing temperature, this material remains in an uncured state. This process reduces the volume of waste material and eliminates the pad removal operation, thereby shortening cycle time. However, precise thermal control is required because a sharp temperature gradient must be maintained across the insulation plate and between the transfer pot and the mold cavities. The temperature profile across the material flow path must be consistent from one cycle to the next to ensure a consistent tear-off of the runners from the molded parts and the transfer pot.

Many thermoplastic elastomers can meet the structural and functional requirements for small resilient parts such as low-compression O-rings, wire harness connectors as well as syringe and tube stoppers. However, the molding technologies employed for thermoset elastomeric rubbers typically cannot be applied directly to thermoplastic elastomers. Injection molding technology offers manufacturing efficiencies in many situations. However, typical injection molding processes for plastics become difficult for very small parts and many thermoplastic elastomers are prone to forming “strings” or “drooling” at the gating sites unless the temperature and other conditions are carefully controlled. Additionally, molding large quantities of small parts, a cold or semi-hot runner system could generate waste from the runner system used to fill the cavities that weighs several times more than the weight of the actual parts produced. High volume molding of small thermoplastic elastomer parts using hot runner type molds results in molding tools of great complexity with limited numbers of cavities and concomitant high mold cost.

### SUMMARY OF THE INVENTION

The subject invention is directed to an apparatus and process for injection transfer molding of thermoplastic elastomers. As noted above, injection transfer molding has been used to make thermoset rubber parts, such as rubber grommets. However, as explained herein, the injection transfer molding of thermoplastic elastomers is vastly different from injection transfer molding of thermoset rubber.

The injection transfer molding apparatus of the subject invention employs a heated transfer plate formed with a melt well for receiving a molten thermoplastic elastomer and for maintaining the elastomer in its molten condition. The heated transfer plate further includes means to urge the molten thermoplastic elastomer through each of a plurality of gates that extend from the melt well.

The injection transfer molding apparatus further includes an insulation plate disposed adjacent and preferably below the heated transfer plate. The insulation plate may have plural layers, and at least one layer, spaced from the heated transfer plate, may be provided with cooling. A plurality of connecting runners or openings for forming sprues extend through the insulation plate and are disposed to communicate with the gates in the heated transfer plate. Thus, the runners or sprue openings through the insulation plate can accommodate a flow of the molten thermoplastic material from the melt well of the heated transfer plate.

The injection transfer molding apparatus further includes a cavity plate disposed adjacent the insulation plate and formed with a plurality of mold cavities therein. The mold cavities are configured to communicate with the runners or sprue openings in the insulation plate and hence can receive the molten thermoplastic elastomer that flows from the melt well in the heated transfer plate and through the runner or sprue opening in the insulation plate. The cavity plate preferably is cooled, and any stripper plate or support plate employed with the cavity plate also may be cooled.

The heating and cooling of the respective plates in the injection transfer molding apparatus ensures that the thermoplastic elastomer in the melt well of the heated transfer plate, as well as the thermoplastic elastomer in the gates leading from the melt well, are maintained above the molten temperature. Additionally, the temperature of the cavity plate is maintained such that the thermoplastic elastomer in the cavities and in adjacent portions of the runners or sprue openings of the insulation plate are cooled sufficiently to solidify. Furthermore, the temperatures of the cavity plate and the shapes of the respective sprue openings or runners are selected to create heat absorption zones of required depth to ensure a clean separation or break of the solidified and molten regions of the thermoplastic elastomer.

### BRIEF DESCRIPTION OF THE DRAWINGS

FIG. 1 is a top plan view of a molding apparatus in accordance with the subject invention.

FIG. 2 is a cross-sectional view of the apparatus of FIG. 1, taken along line A-A.

FIG. 3 is a cross-sectional view of the apparatus of FIG. 1 taken along line 3-3.

FIG. 4 is an enlarged schematic cross-sectional view of a single cavity of the apparatus of FIG. 1.

FIG. 5 is an enlarged schematic cross-sectional view of a single cavity, analogous to FIG. 4, illustrating an alternative gate placement.

FIG. 6 is cross-sectional view of a section of another embodiment of the apparatus of FIG. 1, wherein the part being formed is formed in a cavity gated from one side.

FIG. 7 is a schematic cross-sectional view of a portion of the apparatus of FIG. 6.

FIG. 8 is a schematic top plan view of a portion of the apparatus of FIG. 6, illustrating a cluster of cavities illustrating openings for forming sprues and gate placement.

FIG. 9 is a top plan view of a portion of the apparatus of FIG. 6.

FIG. 10 is a top plan view of another portion of the apparatus of FIG. 6.

### DETAILED DESCRIPTION

While this invention is satisfied by embodiments in many different forms, there are shown in the drawings and herein described in detail, embodiments of the invention with the understanding that the present disclosure to be considered as exemplary of the principles of the present invention and is not intended to limit the scope of the invention to the embodiments illustrated. The scope of the invention is measured by the appended claims and the equivalents.

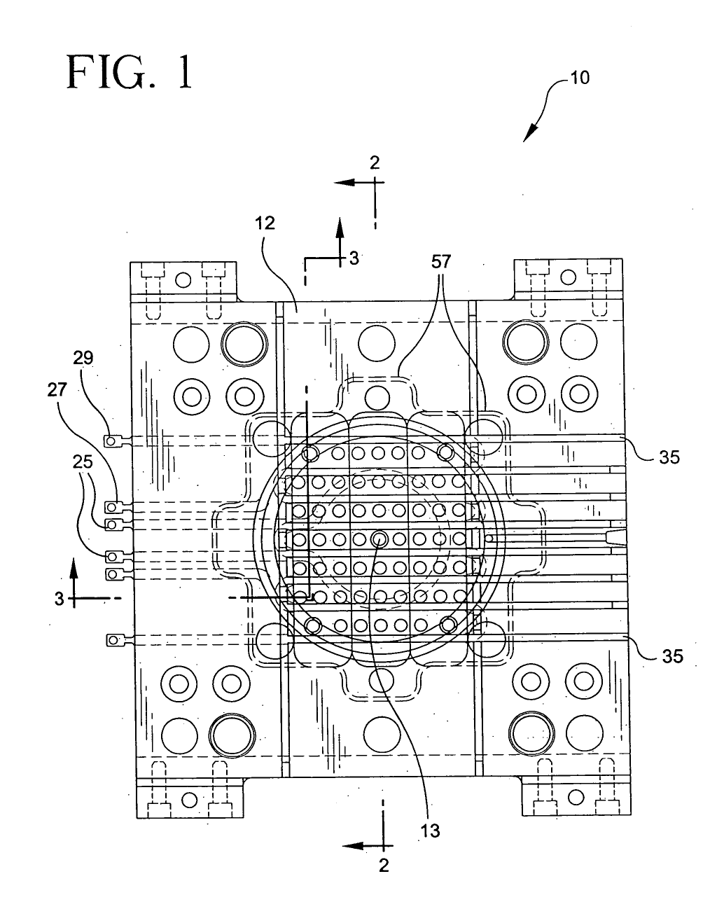

A molding apparatus in accordance with the subject invention is identified generally by the numeral 10 in FIGS. 1-4. Apparatus 10 includes a heated transfer plate assembly 12, a insulation plate assembly 14, a cavity plate assembly 16, a stripper plate 17, a core pin plate 19 and a base plate 21.

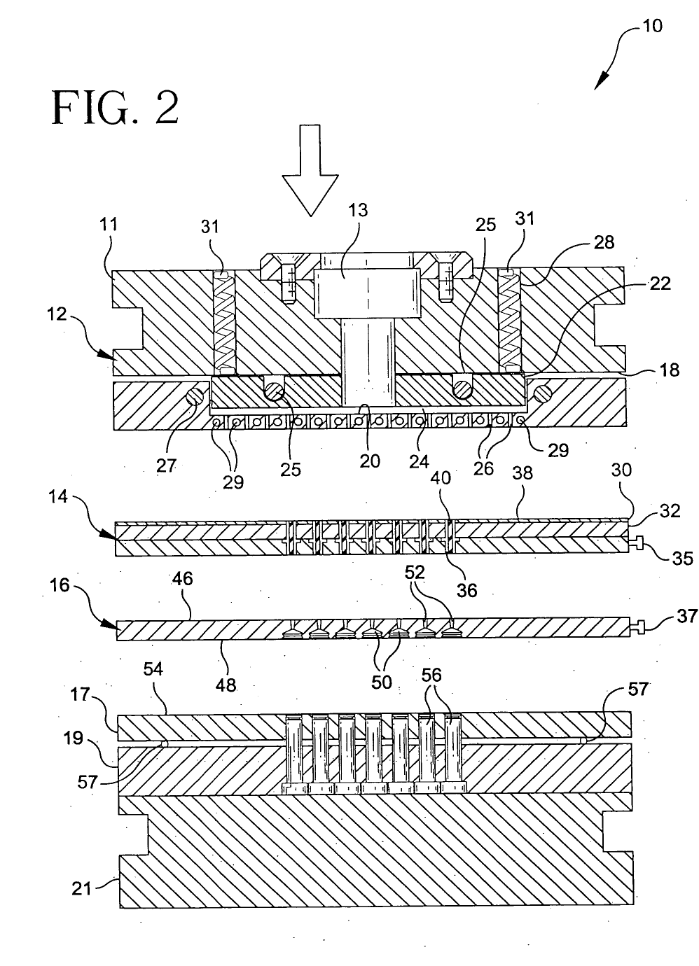

Referring to FIG. 2, transfer plate assembly 12 includes a top plate 11 that has a heated injector nozzle bushing 13 seated therein. Nozzle bushing 13 is secured to top plate 11 with a injector nozzle bushing ring 15. Transfer plate assembly 12 also includes a heated transfer well plate 18 having a substantially planar bottom wall 20 and a side wall 22 extending upwardly about the periphery of bottom wall 20. Bottom wall 20 and side wall 22 define an upwardly open melt well 24 in transfer well plate 18. A plurality of bores 26 extend through bottom wall 20 of transfer well plate 18 and communicate with melt well 24. Transfer plate assembly 12 further includes a heated transfer piston 28 disposed in sliding fluid-tight sliding engagement within melt well 24 for selective movement toward and away from bottom wall 20 of heated transfer well plate 18. Transfer well plate 18 and transfer piston 28 are heated sufficiently to maintain a thermoplastic elastomer that is placed in melt well 24 in the molten state. The heating of transfer well plate 18 and transfer piston 28 is accomplished by a piston ring heater 25, a transfer well ring heater 27 and by a bottom wall transfer plate heater grid 29, best seen in FIGS. 1-3. In particular, a melt well 24 temperature of 425° F. was found to be suitable for molding syringe stoppers in experiments conducted with a thermoplastic elastomer (Santoprene 8211-55, available from Monsanto, St. Louis, Mo.) and with a styrene block copolymer (Kraton 7722X, available from Shell, Houston, Tex.). For forming other types of products from other materials, other melt well temperatures may be more suitable. Transfer piston 28 is operative to generate sufficient molding pressure to urge the melt in the melt well 24 through bores 26 and to form sprues in insulation plate assembly 14 as explained further below. The required pressure depends on the temperature to be maintained in melt well 24 and the number, spacing and sizes of bores 26. A transfer piston 28 capable of producing 1600 psi was adequate for experiments conducted with a 108 cavity one cc syringe stopper mold consisting of eighteen clusters each having six cavities per cluster as described in more detail below.

Insulation plate assembly 14 is disposed beneath and adjacent bottom wall 20 of heated transfer well plate 18. More particularly, insulation plate assembly 14 includes a metallic plate, preferably stainless steel, top plate 30 adjacent bottom wall 20 of the heated transfer well plate 18. Preferably, top plate 30 is between 45 and 60 thousandths of an inch thick for the application of molding 3 cc stoppers. Other thicknesses and other materials that have the ability to act as a heat sink or otherwise rapidly dissipate heat may be suitable for forming top plate 30 as long as the material selected has sufficient compressive strength so as not to be significantly deformed under the stresses that are seen in the molding conditions and may be preferred for some applications. Insulation plate assembly 14 also includes an insulation plate 32 adjacent stainless steel plate 30 and a cooled stainless steel plate 34 adjacent insulation plate 32. A plurality of apertures 36 are formed through insulation plate assembly 14 disposed to align substantially coaxially with bores 26 in bottom wall 20 of heated transfer well plate 18. Apertures 36 define substantially larger diameters than bores 26. Insulated sprue inserts 38 with openings 39 are mounted in the respective apertures 36 and form sprues 40 extending therethrough. Openings 39 extend to align coaxially with bores 26 in bottom wall 20 of heated transfer well plate 18 and hence will accommodate a flow of melt M from melt well 24 and the respective bores 26. Insulation plate assembly 14 functions to isolate the heated transfer plate assembly 12 from cavity plate assembly 16, as explained herein.

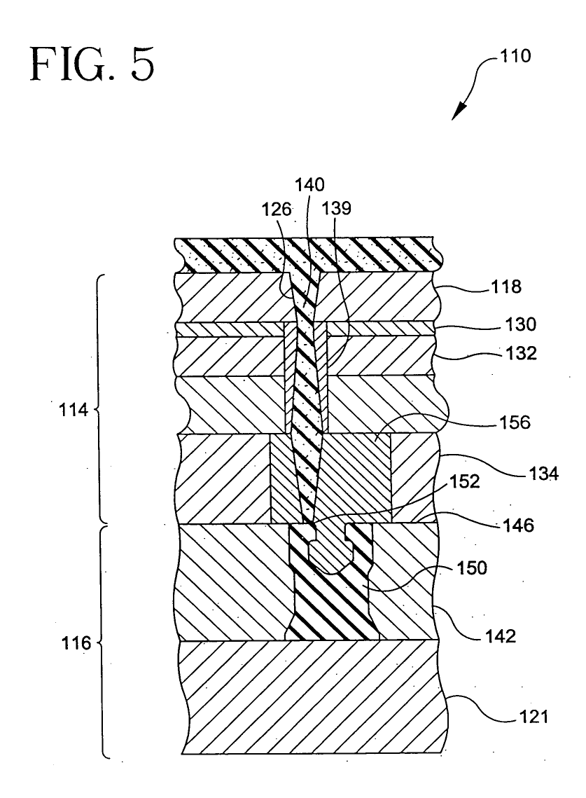

Cavity plate assembly 16 includes provisions for fluid cooled cooling. Base plate 21 is also cooled. Generally, in injection molding operations, chilled water is used a heat exchange fluid, other heat exchange fluids may be preferred for particular applications. Cavity plate assembly 16 includes an upper surface 46 disposed in abutting face-to-face engagement with cooled stainless steel plate 34 of insulation plate assembly 14. Cavity plate 16 further includes a lower surface 48 disposed to abut stripper plate 17. A plurality of cavities 50 are recessed into lower surface 48 of the cavity plate 16 and have shapes selected in accordance with the specified shape of the object, in this example a syringe stopper, to be molded. Cavity plate 16 further includes entry gates 52 that extend into upper surface 46 and communicate with the respective cavities 50. Gates 52 are disposed to be in register with openings 39 and serve to form sprues 40 in insulated sprue plate assembly 16. The particular orientation of cavities 50 and gates 52 illustrated in FIG. 2 are referred to as a “front-gated” mold design. Stripper plate 17 includes an upper surface 54 disposed to abut lower surface 48 of cavity plate 42 for closing the respective cavities 50. In the embodiment shown herein, the base plate further includes core pins 56 that extend into the respective cavities 50 when the mold is closed for filling with molten material. Core pins 56 extend upwardly from pin plate 19 through registered openings in stripper plate 17, so that when assembly 10 is opened with pin plate 19 being removed from core plate 16, the parts formed remain on core pins 56, are detached from sprues 40 at gates 52 and subsequently are removed from their respective core pins by the withdrawal of core pins 56 through the openings in the stripper plate. In some embodiments and for some types of objects, core pins 56 may not be required. (For example, back-gated designs, as illustrated in FIG. 5, the cores may be disposed on the equivalent of plate 34.) Preferably, base plate 21 includes a resilient seal, preferably an O-ring 57, for forming a seal between the base plate and pin plate 19 as the plates are moved together. Preferably, a second resilient seal, again, preferably an O-ring 57, is disposed to form a seal between the top surface of pin plate 19 and the bottom of stripper plate 17. By forming a seal between the plates before the application of sufficient force to move the plates to full intimate physical contact, a reduced pressure may be developed between the plates and in the cavities to facilitate rapid and substantially uniform flow of the molten thermoplastic material from melt well 24 into cavities 50 by transfer piston 28. Preferably, the engagement of the O-rings and development of the reduced pressure occurs when the movement of the mold from the open position to the closed position is about ninety eight percent of the distance that completes the closure of the mold assembly and application of the full packing pressures.

The heating of transfer plate assembly 12 and the cooling of cavity plate assembly 16 is carried out such that the thermoplastic elastomer in melt well 24 and in openings 39 are maintained at or above a temperature for the selected thermoplastic elastomeric material is in the molten state, while the thermoplastic elastomer in the mold cavities 50 is solidified by the cooling of cavity plate assembly 16 to a temperature below the melting point of the thermoplastic elastomer. The location of the transition point of the temperature between the molten state and the rubbery state of the thermoplastic elastomer desirably should be controlled to achieve a clean separation of the molded stopper upon separation from cavity plate 42. Depending upon the particular thermoplastic elastomer selected, the location of this transition can be varied in several ways. One way to alter the location of the transition point is by changing the relative heating and cooling temperatures, by altering the sizes and shapes of sprue openings 39 and gates 52 and by combinations of these changes.

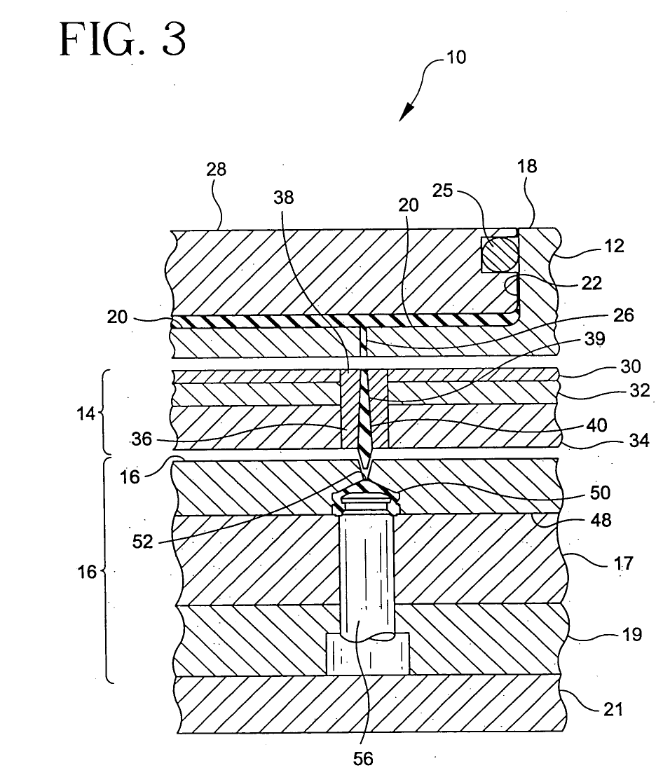

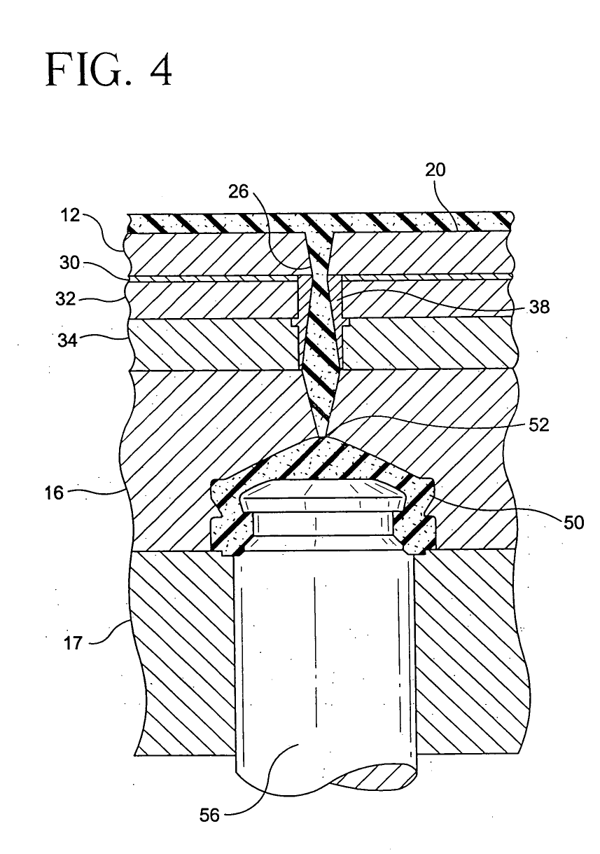

Referring to FIGS. 3 and 4, the widening of sprue opening 39 relative to the gate cross-section at the cavity results in sprue 40 being formed in a tapered shape. As seen in FIG. 4, the portion of sprue 40 adjacent to gate 52 results in a wider gate opening than is seen in FIG. 3. In most embodiments, each gate 52 will taper from a large cross-section adjacent upper surface 46 of cavity plate 42 to a smaller cross-section adjacent cavity 50. Additionally, each opening 39 is preferably shaped to form sprue 40 with a minimum cross-section at a location furthest along the length of the sprue away from gate 52, and larger cross-sections at opposed ends of each sprue 40. The tapered form allows the entire sprue to be removed during a removal operation, e.g., combing, once the material forming the sprue has cooled to a temperature below the melting point of the material. The tapers and dimensions can be varied in accordance with other process parameters, including the sizes of the respective cavities 50, the type of thermoplastic elastomer employed and the required cycle time. A suitable location and careful control of the temperature transition location can substantially eliminate a gate vestige on the finished product, and thereby can minimize or substantially eliminate trimming of the molded part. In these experiments, a cooling water temperature in the range of 50-70° F. has been effective at allowing sufficient control of the temperature transition location. For other applications, other temperatures of the cooling water may be preferred.

The preferred operation of injection molding apparatus 10 includes providing a front gated mold as illustrated in FIGS. 1-4 and includes injecting an amount of molten thermoplastic substantially equal to the volume of cavities 50 plus the volume required to form sprues 40 into the melt well 24 and then using the pressure applied to transfer piston 28 to displace the volume of molten thermoplastic into cavities 50. Preferably, each cavity 50 is connected to melt well 24 by a bore 26 through a gate 52. When used for formation of objects larger than the syringe stoppers used in the present examples, it may be preferred to have several gates 52 for each object to assist the flow of the thermoplastic material into cavity 50. Additionally, it is preferred that all of the openings 39 used to form sprues 40 and their associated gates 52 be disposed substantially within transfer assembly 12. The preferred arrangement of openings and gates allows for placement of a maximum number of cavities in cavity plate with the cavities preferably arranged in clusters for small parts such as the syringe stoppers illustrated herein.

Preferably, molding apparatus 10 is positioned in a substantially horizontal position in an injection molding press so that the abutting surfaces of the transfer plate assembly, the insulation plate assembly and the cavity plate assembly are substantially vertical. The timing sequence of the molding press containing assembly is preselected to inject a preselected amount of molten thermoplastic into melt well 24 prior to the several assemblies of molding apparatus 10 reaching a position, preferably about ninety-eight percent of fully closed, where the O-rings engage the opposing surfaces and develop a seal between the assemblies of the mold. At the time the O-rings engage, a pressure below atmospheric pressure is developed in cavities 56, gates 52 and openings 39. In the present system preferably a vacuum of about thirty inches of mercury is applied to the molding assembly. This reduced pressure facilitates the transfer of the molten thermoplastic material from melt well 24 into cavities 52. As the preferred ninety-eight percent closure is achieved, transfer piston 28 urges, over coming the bias of die springs 31, the predetermined amount of molten thermoplastic from melt well 24 into the openings, through gates 52 to fill cavities 56 and form the desired objects. As the press continues to move the plate assemblies to the fully closed position, the O-rings are compressed and the plate assembly surfaces are fully engaged in face-to-face contact. Molding assembly 10 is then held under the preselected compression for a preselected period of time to allow the molten thermoplastic material to solidify to form the parts. After the preselected residence time the injection molding press opens and the several assemblies are moved away from one another to allow the removal of the now formed parts. The preselected temperatures of melt well 24 and heat transfer fluid in cavity plate assembly 42 are variable by the operator to optimize both the total cycle time and part formation. In the present example, where plunger stoppers for a 1 cc syringe are formed, a 108 cavity mold with cavities formed with eighteen clusters having six cavities was used. In this example, a shot size of about one ounce of molten thermoplastic was delivered into melt well 24. The several assemblies of molding assembly 10 were moved together at a rate about 7.5 inches per second. A vacuum of about 30 in.Hg was applied to the cavity system when the mold plates were at 98 percent closure of full closure. The injection molding press fully closes the mold apparatus and then holds mold apparatus under a compression of about 110 tons for about ten seconds. The several plate assemblies are then separated at a rate of about 2.5 inches per second with the parts being removed and the sprues being removed from the openings, preferably by combing or brushing, within about four seconds. The above reported rates of closing, holding and opening allow for a cycle time of about twenty seconds. For forming objects other than syringe stoppers, other rates, temperatures and cycle times may be preferred and are considered within the scope of the invention.

During the mold filling, cooling and opening sequence, an additional sequence preferably occurs in the transfer plate assembly. As the pressure is released from mold apparatus 10, transfer piston 28 is retracted from bottom wall 20 of melt well 24, preferably by die springs 31 illustrated schematically in FIGS. 2 and 3, to thereby exerting a retraction force on any molten thermoplastic material present in openings 39 and withdrawal of any molten material back into the melt well. Additionally, during the opening sequence, cavity plate 16 is separated from insulation plate 14 and the formed thermoplastic object, in the example a 1 cc syringe stopper, remains on the core pins 56 and is extracted from the cavities 50. As stripper plate 17 is separated from the core pin plate, the formed stopper is removed from core pin 56 and drops into a collector positioned below the mold assembly. As the formed parts are collected, sprues 40 are removed from openings 39 and collected for recycling into the melt. In the present invention, the operator has the ability to preselect the temperature maintained in the melt well, the transfer plate assembly and the cavity plate assembly. By careful selection of these temperatures, the position of the transition point between molten thermoplastic elastomeric material and solid material can be adjusted to be positioned sufficiently within opening 39 so that a substantially clean break-off of the sprue from the formed part is achieved at gate 52. Additionally, the taper of opening 39 toward gate 52 also facilitates the break-off. Further, as described above, the molten thermoplastic is withdrawn back into melt well 24 as mold assembly 10 is opened, so that the problems of “drooling” or string formation at the gate, commonly reported with injection molding of thermoplastic elastomers, on the part is substantially eliminated.

Several experiments have been performed with a front-gated apparatus as illustrated in FIGS. 1-3. The preferred 108 cavity molding apparatus consisting of 18 clusters and six cavities per cluster for forming one cc stoppers. The molding apparatus was tested with a thermoplastic block copolymer (Santoprene 8211-55) and with a styrene block copolymer (Kraton 7722X). In these tests, the temperature of the transfer chamber or melt well was set at 420° F., the molding pressure was 1600 psi and the cool time was 10 seconds with a cooling water temperature at 70° F. The actuator piston was operative to push the thermoplastic elastomers into the cavities in approximately 0.25 seconds. Using these preferred operating conditions with the tested materials, acceptable one cc stoppers were reliably produced. For other materials and other types of parts, other operating conditions may be preferred and are considered within the scope of the invention.

Tests also were performed using metallocene plastomers as the thermoplastic elastomer. In these tests, the transfer chamber temperature was set at 400° F., the molding pressure was 1600 psi, the cool time was 10 seconds and the cooling water temperature was set at 50° F. The metallocene plastomers employed in these tests were Exxon 4006 and Exxon 9053. Parts produced in these tests did not provide a clean tear-off, and parts could not be removed without deformation, due to a high compression-tension set property of the un-cross linked plastomer.

Other tests were employed with a proprietary silane-grafted metallocene plastomer, VTMSi-g-plastomer. These tests showed acceptable parts during the first few cycles, but with poor tear-off. However, the mold could not be filled during subsequent cycles, thereby suggesting that the VTMSi-g-plastomer was cross-linking during the molding process. It is believed that better results could be achieved by performing the process under nitrogen and keeping the residence time as brief as possible.

FIG. 5 shows an alternate embodiment molding apparatus 110 of the invention that is generally referred to as a back-gated mold. In this embodiment, similar parts having similar function to those of FIGS. 1-4 are assigned similar reference numerals with a hundreds digit. Molding apparatus 110 includes a cavity plate assembly 116 with a cooled cavity plate 142 and a cooled base plate 121. Cavity plate 142 includes an upper surface 146 that is formed with a plurality of cavities 150. Base plate 121 is provided for support and cooling. Molding apparatus 110 further includes an insulation plate assembly 114. Insulation plate assembly 114 includes a cooled stainless steel plate 134 having a plurality of core pins 156 disposed to extend downwardly into the respective cavities 150. In this embodiment, cavity plate assembly 116 does not include the stripper plate. In this embodiment, openings 139 preferably register with the respective cavities 150 at locations slightly offset from the respective core pins 156. This back-gated mold offers certain advantages. In particular, any sprue break or trimming operation that may be required is disposed at a location on the stopper away from a location that will be placed in direct communication with fluid in the syringe barrel or a tube. Additionally, the gate location can be selected to be in an area of the object being molded that does not perform a dimensionally critical sealing function. However, a potential for voids in the formed parts exists with the back-gated mold cavity configuration. The potential for voids in the finished product can be substantially eliminated by careful venting of cavity 150 within mold apparatus 110 to allow gas present in the cavity to be readily displaced by the incoming thermoplastic elastomer. The specific venting arrangement will depend on the size and shape of the cavity, the type of thermoplastic elastomer employed and the temperature and pressures.

Similar experiments to those performed with the molding apparatus of FIGS. 1-4 were performed under the above-described conditions on the back-gated molding apparatus of FIG. 5 initially yielded a poor tear-off appearance in the form of a gate vestige. After optimization of mold operating conditions, acceptable parts were produced. When optimized, the back-gated molding apparatus was operated so that the pack pressure was reduced gradually from about 1600 psi to about 300 psi after an initial holding time of about one second, followed by another holding period of about ten seconds. After this optimization, the gate vestige was substantially eliminated. One skilled in the art of forming parts from thermoplastic materials recognizes that in using a back-gated molding apparatus of the invention for forming other parts having other shapes and sizes, other operating conditions may be preferred.

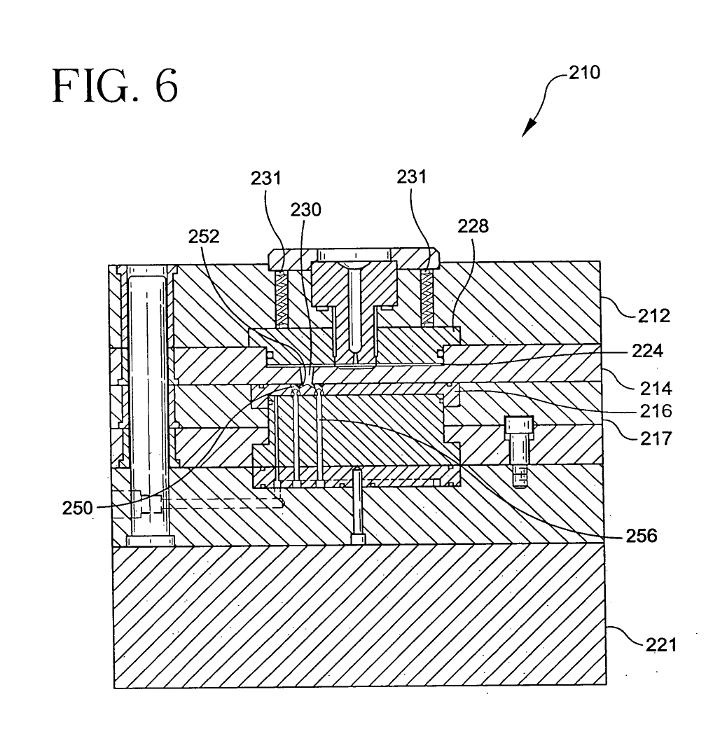

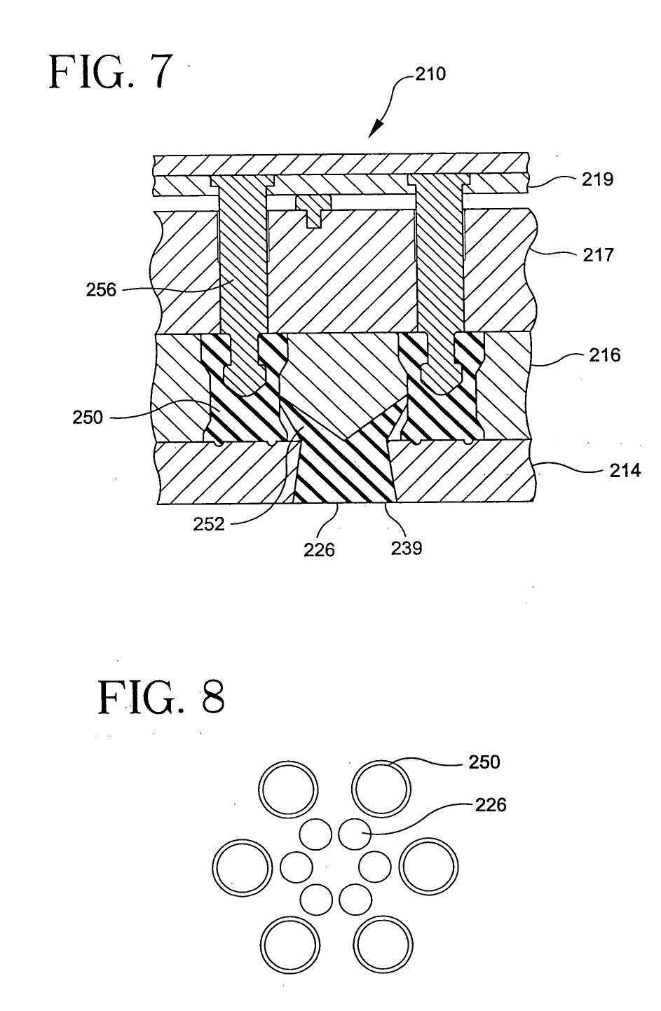

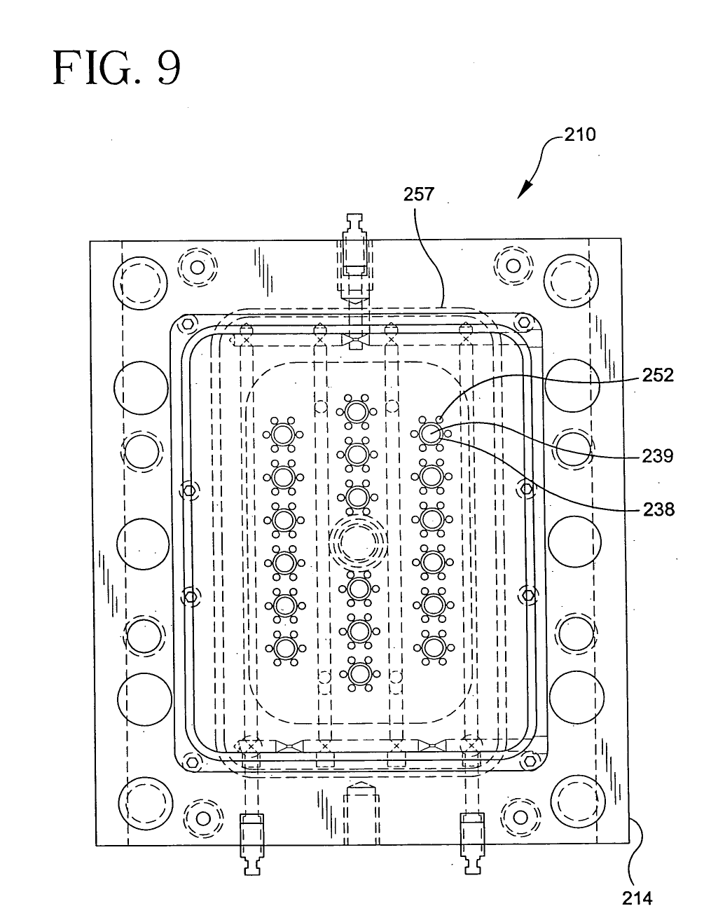

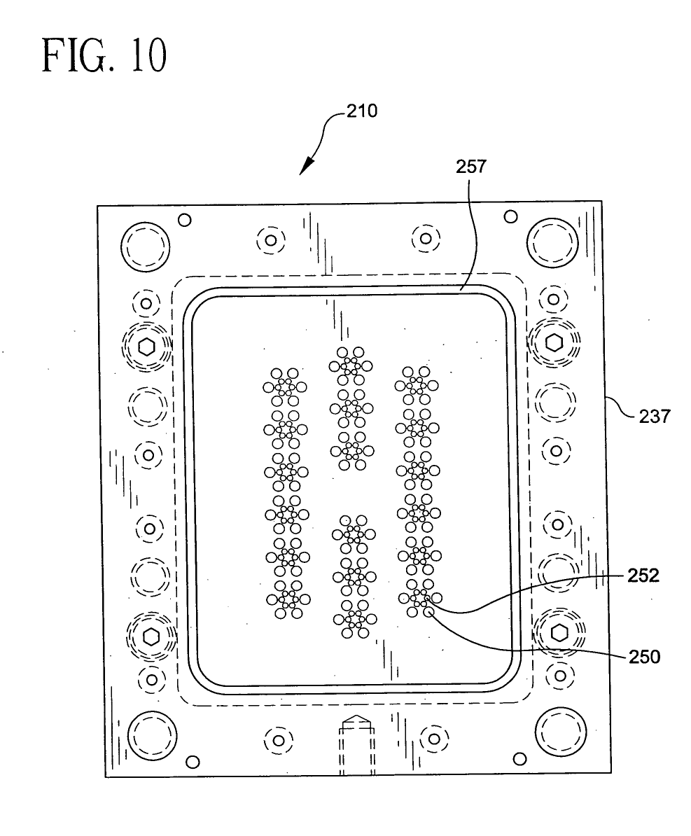

Referring now to FIGS. 6-10, another transfer molding apparatus 210 is illustrated. In this embodiment apparatus 210 includes a heated transfer plate assembly 212, a cavity plate assembly 216, a stripper plate 217, a core pin plate 219 and a base plate 221. Transfer plate assembly 212 includes a top plate 211 that has a heated injector nozzle bushing 213 seated therein. Nozzle bushing 213 is secured to top plate 211 with a injector nozzle bushing ring 215. Transfer plate assembly 212 also includes a heated transfer well plate 218 having a substantially planar bottom wall 220 and a side wall 222 extending upwardly about the periphery of bottom wall 220. Bottom wall 220 and side wall 222 define an upwardly open melt well 224 in transfer well plate 218. A plurality of angled bores 226 extend through bottom wall 220 of transfer well plate 218 and communicate with melt well 224. Transfer plate assembly 212 further includes a heated transfer piston 228 disposed in sliding fluid-tight sliding engagement within melt well 224 for selective movement toward and away from bottom wall 220 of heated transfer well plate 218. Transfer well plate 218 and transfer piston 228 are heated sufficiently to maintain a thermoplastic elastomer that is placed in melt well 224 in the molten state. Transfer piston 228 is operative to generate sufficient molding pressure to urge the melt in the melt well 224 through bores 226 which divides into a cluster of gates 252 then into individual cavities 250. In this embodiment, the size of the part being molded determines how many gates 252 and how many cavities are disposed in each cluster. The required pressure depends on the temperature to be maintained in melt well 224 and the number, spacing and sizes of bores 226. Again in this embodiment, as the clamping pressure is released from assembly 210, and the several elements of the tool are moved apart from one another by the press, die springs 231 cause transfer piston 228 to withdraw away from bottom wall 220 of the heated transfer well plate 218 and substantially urge any molten thermoplastic material present in bores 226 to away from sprue 240 and the molten/solid transition location substantially to eliminate stringing.

Insulated sprue inserts 238 with openings 239 are mounted in 226 the respective apertures 236 and form sprues 240 extending therethrough. Openings 239 extend to align diagonally with bores 226 in bottom wall 220 of heated transfer well plate 218 and hence will accommodate a flow of molten thermoplastic from melt well 224 and the respective bores 226 to flow into cavities 250 through gates 252.

Cavity plate assembly 216 includes provisions for fluid cooled cooling. Base plate 221 is also cooled. A plurality of cavities 250 are recessed into lower surface 248 of the cavity plate 216 and have shapes selected in accordance with the specified shape of the object, in this example a syringe stopper, to be molded. Cavity plate 216 further includes entry gates 252 that extend into upper surface 246 and communicate with the respective cavities 250. Gates 252 are disposed to be in register with openings 239 and serve to form sprues 240.

The apparatus and method of the invention provide thermoplastic elastomeric parts that are substantially free of secondary trimming operations. The apparatus of the method greatly reduces the amount of regrind material present in conventional cold runner molding tools. In molding objects with the apparatus and method of the invention, the only material not being utilized as formed objects is that used to form sprues, this material is in small enough pieces that no secondary regrinding operation is necessary. The sprues can readily be ejected from the molding tool by combing, air blast or the like and directly returned into the injection screw feed hopper to be remelted. The apparatus and method of the invention provide equivalent quality to the parts produced by conventional compression molding, while eliminating the problems and costs associated with secondary trimming operations and waste.

1. An injection molding apparatus for forming objects from a thermoplastic elastomer comprising:
a heated transfer plate assembly including a transfer well plate having a melt well therein being maintained at a sufficient temperature for accommodating a thermoplastic elastomer and maintaining the thermoplastic elastomer in a molten state, a transfer piston within said melt well selectively operable to displace at least a portion of the thermoplastic elastomer from said melt well, a plurality of bores extending through said transfer well plate and communicating with said transfer piston, the transfer well plate being disposed for receiving the thermoplastic elastomer selectively displaced from said melt well;
an insulation plate assembly adjacent said transfer well plate, said insulation plate assembly having a top plate, an insulation plate and a cooled plate, said insulation plate having a plurality of openings therethrough for forming sprues of the thermoplastic elastomer therein and for isolating said heated transfer from said cooled plate, said openings being aligned respectively with said bores of the transfer plate assembly; and
a cooled cavity plate assembly having a plurality of mold cavities for forming objects disposed therein, said mold cavities being registered respectively with said openings of said insulation plate assembly so that when the molten thermoplastic elastomer is displaced from said melt well by said transfer piston, said cavities are substantially filled with said molten thermoplastic elastomer, said cavity plate assembly being maintained at a temperature preselected to solidify the thermoplastic elastomer therein thereby forming the thermoplastic elastomer into the objects in said cavities;
wherein said cavity plate assembly further comprises a pin plate having a plurality of core pins disposed thereon, said pin plate being disposed so that said core pins are disposed within said cavities when said injection molding apparatus is disposed to receive the molten thermoplastic elastomer;
wherein said molding apparatus further comprises a stripper plate disposed between said pin plate and said cavity plate having sufficient passageways therethrough so that when said molding apparatus is disposed for receiving the molten thermoplastic elastomer, said core pins are disposed within said cavities and when said pin plate is moved to a position away from said cavity with said formed objects being removed from said cavity on said core pins, a movement of said stripper plate away from said pin plate causes the formed objects to be displaced from said core pins; and
wherein said molding apparatus further includes a resilient seal between said pin plate assembly and said stripper plate assembly and a resilient seal between said stripper plate assembly and said cavity plate assembly so that as said plate assemblies are moved from a position wherein said assemblies are spaced apart from one another to a position wherein said assemblies are in intimate physical contact, said resilient seals engage said adjacent assemblies prior to intimate physical contact thereby forming a seal to facilitate a development of a pressure below atmospheric pressure in said cavities thereby facilitating said cavities being filled with said molten thermoplastic material, said resilient seals then being sufficiently compressible to allow said assemblies to make intimate physical contact when sufficient clamping pressure is applied.

2. The molding apparatus of claim 1, wherein said cavity plate further comprises a plurality of channels formed as void areas therein and wherein said apparatus further includes a supply of a heat exchange fluid for circulation in said channels for selectively maintaining a preselected temperature in said cavity plate.

3. The molding apparatus of claim 1 further comprising said cavity plate having a plurality of gates therethrough extending from said respective cavities to said openings in said insulation plate assembly thereby providing a pathway for transmitting the molten thermoplastic material from said openings in said insulation plate into said cavities.

4. The molding apparatus of claim 3 further comprising each of said gates being tapered to define a large cross-section adjacent said each respective opening and a small cross-section adjacent said each respective cavity, so that when the sprue is formed from the thermoplastic material in said opening after said cavity is substantially filled with the thermoplastic material, a small cross-section portion of the sprue is adjacent to said cavity.

5. The molding apparatus of claim 4 further comprising each of said bores being tapered to define a large cross-section adjacent to said melt well and a small cross-section adjacent to the sprue formed in said opening.

6. The molding apparatus of claim 5 wherein a temperature gradient within insulation plate assembly can be preselected and changed thereby to determine and locate a transition point of said temperature gradient between a temperature above the temperature sufficient to keep the thermoplastic elastomer in the molten state and a temperature below the temperature necessary to keep the thermoplastic elastomer in the molten state.

7. The molding apparatus of claim 5 wherein said cooled plate of said insulation plate assembly further comprises said cooled plate having a plurality of channels formed as void areas therein and wherein said apparatus further includes a supply of a heat exchange fluid for circulation in said channels for selectively maintaining said cooled plate at a preselected temperature.

8. The molding apparatus of claim 7, wherein said top plate of said insulation plate assembly comprises a stainless steel plate between said insulating plate and said heated transfer plate assembly.

9. The molding apparatus of claim 8 wherein said top plate has a thickness of between forty-five to sixty thousandths of an inch, and wherein a preselected change in said thickness of said plate causes a preselected change in said temperature gradient in said insulation plate assembly.

10. A method for injection transfer molding of objects from a thermoplastic elastomer, said method comprising:
providing a molding apparatus including a transfer plate assembly having a melt well with a transfer piston therein, a cavity plate assembly having a plurality of cavities therein, and a insulation plate assembly having openings therethrough between said transfer plate assembly and said cavity plate assembly for providing fluid communication between said melt well and said cavities, said assemblies of plates being movable between a first position wherein said plate assemblies are spaced apart and a second position wherein said plate assemblies are in intimate physical contact;
heating said transfer plate assembly to a preselected temperature;
placing a material in said melt well comprising a thermoplastic elastomer having a melting temperature below said preselected temperature of said melt well;
maintaining said cavity plate assembly at a preselected temperature lower than said melting temperature of said thermoplastic elastomer;
moving said plate assemblies from said first position to said second position;
applying sufficient pressure to said molten thermoplastic elastomer in said melt well to move said transfer piston toward a bottom surface of said melt well for urging said molten thermoplastic elastomer from said melt well, through said insulation plate assembly and filling said respective cavities of said cavity plate assembly, said pressure being applied for a sufficient time to substantially fill each said cavity;
holding said thermoplastic elastomer in said cavities for a sufficient time for the thermoplastic elastomer therein to solidify and form the objects; and
opening said molding apparatus by separating said plate assemblies one from another so that said transfer piston can withdraw away from said bottom surface of said melt well thereby withdrawing molten thermoplastic elastomer from said openings in said insulation plate; and
removing the formed objects from said cavities after the solidification.

11. The method of claim 10, wherein said heating of said transfer plate to said preselected temperature further comprises preselecting a temperature about 420° F. thereby maintaining said thermoplastic elastomer in the molten state.

12. The method of claim 11, wherein said moving and said applying sufficient pressure steps further comprises moving said plate assemblies a sufficient distance and applying sufficient pressure to said molding apparatus to urge a closing between said insulation plate assembly and said cavity plate assembly to less than a full closure;
maintaining said first sufficient pressure for a preselected period of time;
applying a second sufficient pressure to said molding apparatus sufficient to urge a closing between said insulation plate assembly and said cavity plate assembly to full closure; and
maintaining said second sufficient pressure to said molding apparatus for a sufficient time to allow the thermoplastic material to form the objects.

13. The method of claim 12 wherein said applying step of applying sufficient pressure to said molding apparatus further comprises applying a packing pressure between about 300-1600 psi.

14. The method of claim 10, wherein said maintaining said cavity plate assembly at said preselected temperature further comprises cooling said cavity plate with a heat exchange fluid at a temperature in the range of approximately 50-70° F.

15. The method of claim 10, wherein said placing step for said thermoplastic elastomer further comprises selecting a block copolymer as said thermoplastic elastomer.

16. The method of claim 15 wherein said placing step further comprises selecting a styrene block copolymer.
